(19) United States
(12) Patent Application Publication
(10) Pub. No.: US 2005/0010649 A1
(43) Pub. Date: Jan. 13, 2005

(54) Integrated security suite architecture and system software/hardware

(76) Inventors: Ray Payne, Sierra Madre, CA (US); Shaiwal Priyadarshi, Pasadena, CA (US); Jerry Herbert Shaw, Barstow, CA (US); James Oakley Lowder, Hemet, CA (US)

Correspondence Address: George R. Schultz;Schultz & Associates, P.C., One Lincoln Centre, 5400 LBJ Freeway, Suite 525, Dallas, TX, 75240, US

(21) Appl. No.: 10/843,180

(22) Filed: May 11, 2004

Related U.S. Application Data
(60) Provisional application No. 60/483,751, filed on Jun. 30, 2003.

(51) Int. Cl. G06F 15/16

(52) U.S. Cl. 709/217

(57) ABSTRACT

Disclosed is a multi-user, multi-tasking, state-of-the-art computer-based package for providing real-time distributed processing and control of a variety of system functions and capabilities. The invention provides an integrated security suite architecture and system software/hardware combination for security operations. The suite employs a Digital Media System (DMS) to provide live and recorded closed circuit TV (CCTV) capability and audio surveillance. The suite blends a host of modular software/hardware plug-ins that provide seamless integration of intrusion detection systems (IDS), access control systems (ACS), and management reporting systems (MRS) for efficient and effective security management plans for new or existing operations. Also provided is an open architecture system design and configuration which provides maximum reliability, interoperability, flexibility, and operational efficiency. Various Ethernet technologies are employed and comprise IEEE 802.3, 802.3u, 802.11b, and Home Plug (HP) and use standard TCP/IP protocols to allow for building-wide, metropolitan, and global communications.

### CROSS REFERENCE TO RELATED APPLICATIONS

This application claims the benefit of U.S. Provisional Application No. 60/483,751, filed Jun. 30, 2003.

### FIELD OF INVENTION

This invention relates to an integrated security suite architecture and system software/hardware combination for security operations employing the Digital Media System (DMS) to provide live and recorded closed circuit TV (CCTV) capability and audio surveillance and more particularly to an integrated security suite blending modular software/hardware plug-ins that provide a seamless integration of intrusion detection systems (IDS), access control systems (ACS), and management reporting systems (MRS) for efficient and effective security management plans for new or existing operations.

### BACKGROUND OF THE INVENTION

Within the security industry there exists two main types of customers: 1) those that have a need for only one security function; and, 2) those that insist upon a complete range of integrated security components. For those that have a need for only one security function (e.g., monitoring a building) current security management systems typically consist of individual autonomous systems and/or components for intrusion detection, alarm management, access control, and audio and video surveillance and recording. Any necessary integration of such individual autonomous systems or components is typically left to the installer; integrator, and user or simply does not exist at all. As a result of this conventional design system methodology, companies will have individual unique designs with limited integration capability. This limitation produces an inefficient use of available resources having multiple data entry points and duplicate databases within the system operation. In addition, this limitation creates inefficient use of personnel by duplicating data entry tasks, requires manual data exchange between systems by user personnel, and implements multiple training requirements for the various systems being utilized.

Also created is the unnecessary expense of additional hardware and software accompanied by multiple stand-alone units having similar functionality. This causes unreliable security due to personnel confusion, inconsistent training, and lack of efficient procedures. Furthermore, compatibility is often lost due to continuous upgrades on various portions of systems controlled by separate manufacturers. This in itself creates significant difficulty in troubleshooting problems that arise and encourages finger pointing among the different system component suppliers. Traditionally, a limitation on the integration or even interfacing of these individual systems has been based on the physical constraints of a conventional communications technology employee. Additional limitations lie in the lack of simple, efficient, and effective software and hardware integration not to mention the cost of building systems that are each one of a kind.

The current trend for those who require having a complete range of integrated security components (e.g., large federal and state government agencies as well as large corporate entities) is to have security systems dispersed at local and remote sites that can also be centrally monitored, allowing system administrators at a central control center to oversee activity at remote facilities. What is needed therefore is an efficient security management system wherein multiple system types and technologies can operate simultaneously and effectively to obtain the required information and data. Such a security management system should be one single system with integrated management of intrusion detection to provide alarm and event monitoring, reporting and response; access control to provide controlled and managed access to property and assets, as well as for the creation of personal identification badges and associated database management; management reporting to provide report level information of system database, event history, and general system operation; and, audio and video media that provides coherent, integrated and managed access to as many channels of audio and video and other medias as any customer may require.

CCTV systems have utilized digital video transmission devices to throw video across long distances at cheap costs for the past several years. Despite the benefits, there are some well-known problems with analog transmission. Examples are high signal bandwidth which requires dedicated and costly cable for each video channel and true analog long distance transmission, high susceptibility to interference causing video quality degradation along the transmission path as well as on the record media, and little compatibility with modern processing methods and as computers are utilized more and more requiring analog signals need to be converted to digital more frequently.

Digital systems do provide a host of benefits, which makes them worth-while. For example, digital systems combine video compression with Ethernet networks thereby allowing hundreds of video signals to be transmitted across a communication means, such as a single twisted-pair CAT-5 cable. Digital systems offer noise tolerant transmission and recording thereby providing clean images even when the cable is routed past inductive lines and even when recording on re-used tapes. Also digital data from the sensor to the screen allows for better integration of audio & video components and easy linking of multiple remote and local locations.

While digital transmissions overcome some of the limitations of analog signals, digital transmissions can introduce a set of new problems. For example, “codec artifacts” or blocky or fuzzy images caused during the video compression stage can render the digitally acquired images useless, high latency and partial image display due to delays and errors in the transmission medium, and incompatibilities between different digital solutions.

Before network switches were used, networks were built using non-intelligent, non-routing devices known as “hubs”. Infrastructures based on these hubs share the bandwidth of the network across all of the interconnected devices. Today, modern Ethernet networks, such as 100Base-T (megabit) or even 1000Base-T (gigabit) are typically built using devices known as “network switches”, or just “switches”, and are therefore called “switched networks.” Switched networks intelligently route traffic to exactly those parts of the network where the traffic is required to go. So, for example, any pair of communicating devices will only use bandwidth on the network ports that interconnect them. This eliminates bandwidth waste as data is only sent to those segments of the network that connect the receiver(s). Hence, a 24-port 100Base-T network switch can actually have a total throughput of 2.4 Gbps: 24 ports×100 Mbps per port. Even though only 60% of that bandwidth can actually be used for multimedia streams, this capacity is more than enough to carry hundreds of high-quality video channels. The limitation of 60% sustained utilization of a network applies to and is due to the physical nature of Ethernet which supports higher peak (or burst) transmission rates, but averages at this level over time.

One of the many problems with the prior art is not whether a network can support hundreds of channels of video but whether those hundreds of channels can be managed well. What is needed then is a system that can satisfy customer requirements at multiple system levels: from customers who have a need for only one security disciplines to those who require the complete range of integrated security components. Such a system must be comprehensive in nature, be adaptable to each customer's needs and be a fully integrated, seamless, effective, and efficient platform.

### SUMMARY OF THE INVENTION

The present invention provides security professionals with comprehensive and integrated tools to effectively and efficiently do their jobs by providing a modular approach to their security needs that can satisfy customer requirements at multiple system levels. By using this modular approach, customers having small scale or larger scale multi-security requirements can upgrade and expand their initial installations by simply plugging in any required hardware/software modules to meet their needs. This allows for a much higher return on investment than security systems of the prior art.

The network topology used herein allows for the ability to add security suite components (“plug-ins”) comprising access control, alarm management, and audio/video storage and control functions to an existing Ethernet Local Area Network (LAN) or to build a separate dedicated security network. Additionally, in larger, global based corporations, Wide Area Network (WAN) connectivity based on TCP/IP communications allows geographically separate sites to be accessed, operated, and controlled as if they were one large site with a single system, a true virtual system topology.

Embodiments of the present invention are capable of integrating dispersed systems where there is a local control with links back to a central control center for local and remote monitoring.

There are no limitations of scale using the methodology herein. This approach allows the deployment of equipment to directly match the customers' requirements and effectively allows scalability to be instituted to a few devices at many sites, many devices at a few sites, or many devices at many sites. The scale is virtually unlimited.

Additional embodiments of the present invention allow for workstations to be connected to any of the servers on the network without the need to change the user interface. Once the workstation is connected to a server, the workstation will begin receiving activity from that server just as if the system were connected to a single server. Additionally, the present invention can connect small sites to a single server via networked filed controllers, or can connect to servers from across the country or around the globe.

In addition, other embodiments of the present invention provide for a digital media system (DMS) that rationalizes and governs all aspects of the technologies required to provide a successful digital alternative to analog CCTV. Features of the DMS comprise high-quality audio & video digitization, compression and transmission through the use of high-fidelity, full-resolution and high frame-rate compression techniques. A major portion of the hardware included in the present invention offers direct-connect Ethernet communications to system computers, field controller panels, fixed or dome cameras, and digital media recording system (DMRS) servers. This capability results in a simple and very cost-effective equipment installation method. For example, the installation of a camera now results in nothing more than mounting it, connecting it to a power source, and connecting a communication means such as a CAT-5 network cable and start delivering 30 fps video back to a monitoring station or recorder.

The DMS further provides for unrestrained scalability of numbers of deployed units that are useful in localized and global applications due to LAN and WAN access via Ethernet connectivity based on TCP/IP communications. The DMS is further designed with plug-and-play devices that allow for simple, convenient, and rapid deployment of digital media networks. In the DMS, whenever devices are attached to a network, the device management software can immediately start communicating with the device, which allows for the immediate inclusion of that device into the security system as a whole. If devices are ever replaced, the previous device's configuration can be imported or “dragged and dropped” onto the new device, thereby reducing the amount of time any particular environment is unprotected to the absolute minimum.

In an embodiment of the present invention all monitors and recorders are connected to a core network, defined herein, and have access to all the video channels being transmitted on that core network. Just like analog systems, and unlike most digital solutions, there is no degradation when more than one viewer connects to a video channel because the video is already at full resolution and full frame rate. For similar reasons, which distinguish it from other digital solutions, the DMS rules do not degrade the video quality on the core network when a video channel is “exported” across an external network, such as the Internet or an ISDN line. By utilizing the same core/external data-rate buffering technology, the DMS also allows immediate & real-time review of recorded video at playback stations, even when the playback stations are separated from the recorder by an external network. This unique aspect of the DMS removes the need to first transfer or buffer the video clip at the playback station, an aspect which uses both the operator's time and the network's bandwidth inefficiently and unnecessarily. When an interesting recording has been found, that recording, or a portion of it, can be exported to the operator's PC, where it can then be viewed in the high-fidelity at which it was recorded.

Consequently, a video-switching network can be expanded by simply attaching new cameras or monitors or recorders, updating the management software with the details of the new devices and enabling the new system configuration. There is absolutely no re-wiring or expensive component to upgrade. One of the key areas enabled by moving to networked devices is the ability to control and monitor any device at any time. With this level of simplicity, video switching and installation costs shrink while expanding the level of operational capability.

The accompanying drawings, which are incorporated in and constitute a part of this specification, illustrate, but do not serve to limit, the various embodiments of the present invention and, together with the description serve to explain the principles of the invention.

### BRIEF DESCRIPTION OF THE DRAWINGS

A better understanding of the invention can be obtained from the following detailed description of one exemplary embodiment as considered in conjunction with the following drawings in which:

FIG. 1 is a diagram depicting the integrated security suite application framework of the present invention;

FIG. 2 is a diagram depicting the network topology and component deployment in the integrated security suite of the present invention;

FIG. 3A is a diagram depicting an integrated digital controller network with security management system components and panel modules of the present invention;

FIG. 3B is a diagram depicting an overview of the security management system with NLC/COMM board and associated field control modules of the present invention;

FIG. 4 is a diagrammatic example of a network centric system configuration of the present invention;

FIG. 5 is a diagrammatic example of a stand-alone system configuration of the present invention;

FIG. 6 is a diagram depicting a hybrid analog and digital network system including integrated 3^{rd} party domes and matrix switcher combined with a Digital Media Recording System (DMRS); and,

FIG. 7 is a diagram depicting the Digital Media System (DMS) architecture with associated IP devices and Core and External networks as defined by the present invention.

### DETAILED DESCRIPTION OF THE INVENTION

In the descriptions that follow, like parts are marked throughout the specification and drawings with the same numerals, respectively. The drawing figures are not necessarily drawn to scale and certain figures may be shown in exaggerated or generalized form in the interest of clarity and conciseness.

### Framework and Architecture for the Integrated Security Suite

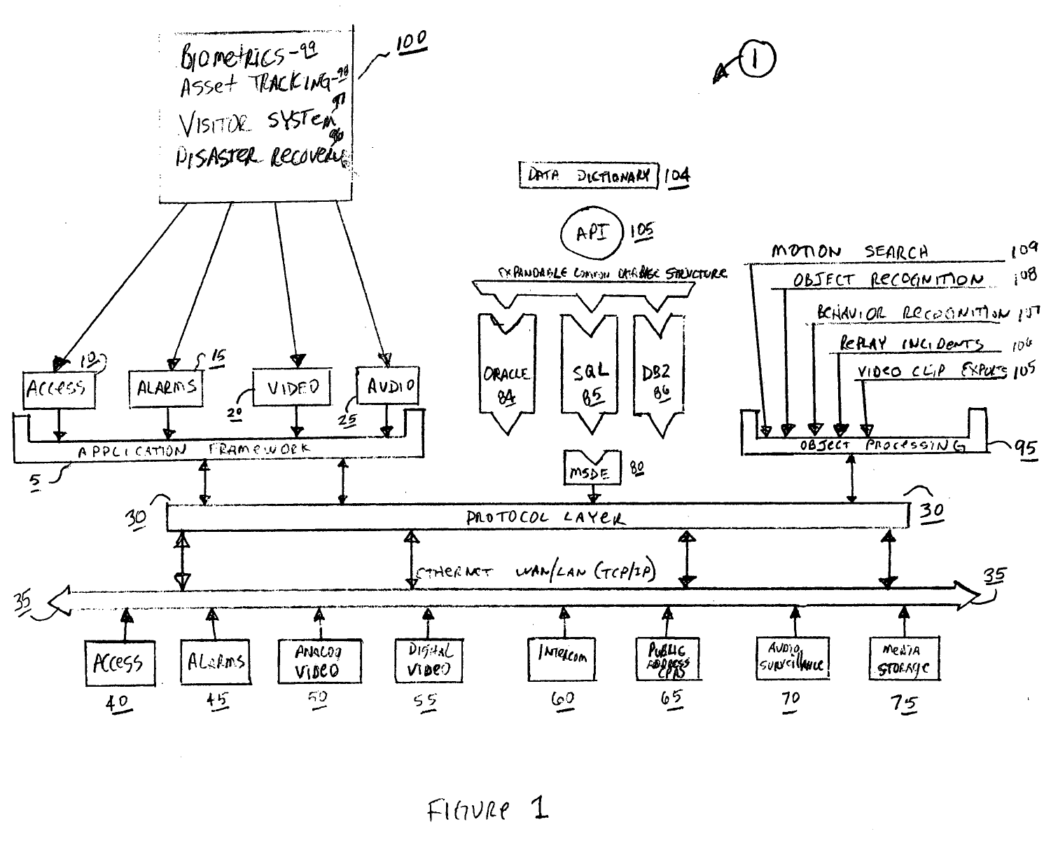

As shown in FIG. 1, the SAFEnet™ security suite system 1 and application framework 5 software of the present invention provides basic system 1 operational features such as authenticated access and control of system 1 information and options to utilize various database tables (e.g., oracle 84, SQL 85, and DB2 86) as well as system control, monitoring, response, and logging functions. The system's 1 application framework 5 and architecture is expandable using at least two levels of modular software product suite plug-ins as depicted in FIG. 1.

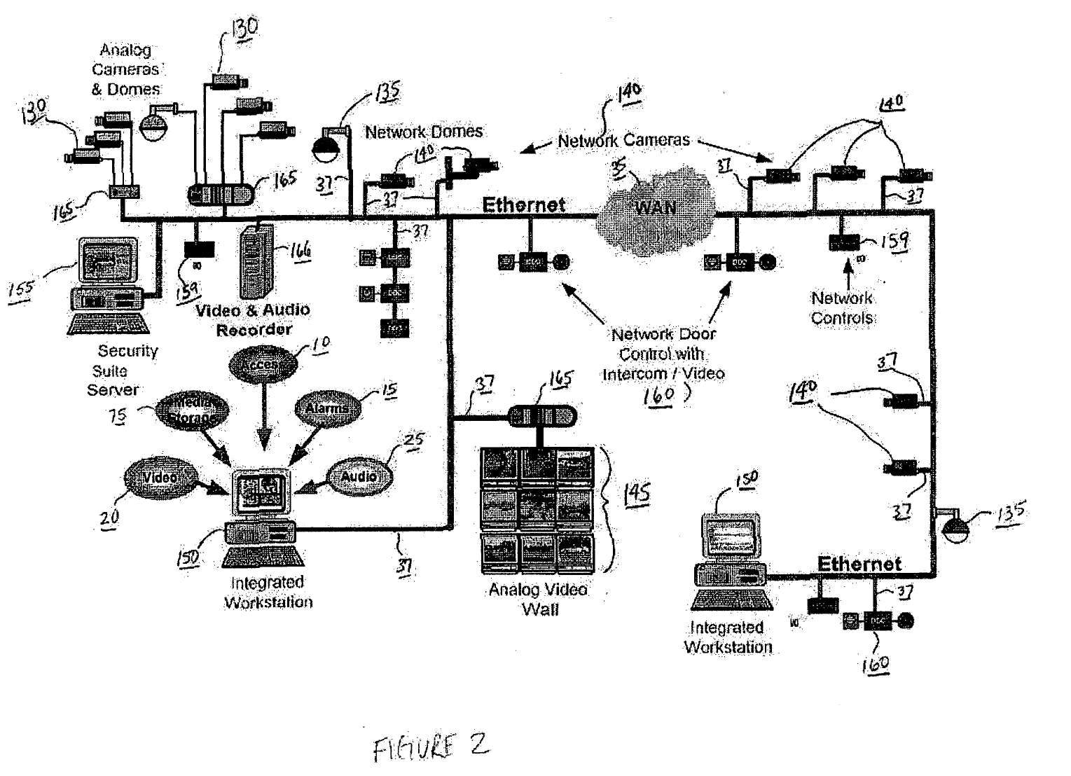

In further reference to FIG. 1, the application framework 5 is built on a base functional program designed as a two-tier client/server 150, 155 system (as shown in FIG. 2) which communicates over standard 10/100/1000 Base-T Ethernet 35 using TCP/IP 35 protocols to interconnect all components and devices. The Ethernet 35 technologies employed within the security suite include IEEE 802.3 and 802.3u (wired UTP CAT-5), 802.11b (wireless 2.4 GHz) and HomePlug (HP), while the use of standard TCP/IP protocols 35 allow for instantaneous building-wide, metropolitan, and global communications. The following comprises a non-exclusive list of system capabilities per server and is intended to provide only a representation of capabilities and is not intended to be limiting in scope:
Over 49,000 alarm input points
Over 49,000 relay output points
Unlimited intrusion detection accounts
Up to 99 arming control codes per account (representing people authorized to open or close an area)
Unlimited dispatch files
Unlimited command files
On average more than 325,000 transaction log records per gigabyte of storage.

Central system capable of sustaining over 120 transactions per second
Unlimited time controlled events
Unlimited database reports with over 100 existing report templates
Integrated report writing utilities
Interactive graphical map displays
Unlimited graphical maps
Global linkage capability (any alarm point can be linked to any output on the server)
Message vectoring by time and by workstation failure or shutdown
Virtual server monitoring, any or all server monitoring at any workstation network-wide
Several disaster recovery configuration options to meet virtually any budget
Application manager service that ensures that critical programs are never stopped
Integration provides for alarm and access control messages to share the same action devices

In the application framework 5 there are four general functional areas of product suites that serve as software plug-ins. These plug-ins include, but are not limited to, access control 10, alarm management 15, digital video 20, digital audio 25, and audio/video and control function media storage 75 through the use of a digital media recording system (DMRS) 75. These plug-in modules are fully functional and when installed, in plurality or individually, the application framework 5 accompanies the installation much the same way as when only one component feature of Microsoft Office (e.g., Word) is installed.

Extending value to the product suite plug-ins are a plurality of technologies 100 which operate mutually exclusively as relating to the individual plug-ins (10, 15, 20, and 25). Each technology 100 will now be explained as it relates to the access control 10 plug-in specifically. It is understood that each technology 100 will operate similarly but uniquely to each plug-in. For example, a biometrics 99 portion may be added to access control 10 which would mean that instead of having only a card reader at a door, the user could add a fingerprint detector. By adding asset tracking 98 the user enables a detect status, location, physical aspect, or movement of assets (e.g. PC, humans, vehicles, etc.). Similarly, by adding a visitor system 97 an end user can restrict the movement of visitors around a building or complex of buildings. This effectively limits visitors to certain areas and triggers alarms if a visitor enters an unauthorized area. By adding disaster recovery 96 central system failures can be safe-guarded against by the utilization of redundant servers, redundant networks, or any other viable backup system. More specifically under disaster recovery 96, the present invention provides for intelligent card readers having the ability to operate even if the primary system goes down, by maintaining local copies of card-holder information. The general objective of disaster recovery 96 is to keep the on-site security system running even when the main system is experiencing a failure.

The system architecture 1 and framework 5 provides a rational blend of data networking technologies and applications via the individual software plug-ins that provide a seamless integration of intrusion detection, access control, and CCTV into a simple and effective system 1. Such framework architecture 5 permits upgrade of older existing analog systems simply by plugging-in a desired module (10, 15, 20, 25, 40, 45, 50, 55, 60, 65, 70, and 75) as the need develops. The operational equivalent idea is that the invention provides for a PCB motherboard and onto that motherboard the user can connect an access control board, an alarm management board, an audio/video board, and/or media storage control board. The benefit of such architecture is that each of these modular component plug-ins connects to a network backbone as do all appliances of the present invention.

FIG. 1 further shows a plurality of network appliance devices that also operationally act as plug-ins having controlling software loaded thereon and also connect to the network backbone 35. Such network appliance device plug-ins comprise Access appliances 40 (e.g., card readers reading magnetic strip cards, and pin pads etc.), Alarm management appliances 45 (e.g., passive IR detectors detecting heat and motion to set off trigger conditions in the form of electrical circuit closure due to voltage changes; alarms which send an alarm packet onto the network 35 etc.), Analog video 50 appliances (e.g., analog cameras, monitors, etc.), Digital video 55 appliances (e.g., compression/“codec” cards, IP cameras etc.), Intercom appliances (e.g. when associated with access control 40 the appliance may have an intercom system at a door to enable communications by a guard and person at the door, can include microphones associated with cameras, etc.), Public address 65 appliances (e.g., microphones to broadcast announcements over speakers in a building in a digital format using standard equipment and standard Ethernet 35 and standard IP, etc.), Audio surveillance 70 appliances (e.g., microphones randomly situated in a building etc.), and Media storage 75 appliances (e.g., the ability to store digital video/audio into a network accessed database of files as presented by the present invention as relating to the DMRS and being operated by the Client side GUI (DMRS further explained below)).

Each of the above plug-in appliances contains effectively two halves of software to the component. Specifically, one half of the software feature is installed in a background system such as a server or network appliance. The other half is installed onto a workstation wherein the workstation then provides the user with the ability to access any network appliance (40, 45, 50, 55, 60, 65, 70, and 75).

The systems 1 is built upon a database management package such as Microsoft SQL 2000 85, MSDE 80, Oracle, or DB2, but are not limited to these specific databases. The present invention performs report generation utilities via a structured query language (SQL) based report generation package such as MDI Report Writer or Seagate Crystal Reports. The system 1 architecture as relating to the use of databases is designed to allow the end user to decide what database is to be used. Therefore, in essence the database operates as a plug-in decided by the user. A database dictionary 104, working in conjunction with a selected database, defines the basic organization of the chosen database. As is known in the art, a data dictionary contains a list of all files in the database, the number of records in each file, and the names and types of each field.

The data dictionary 104 contains bookkeeping information for managing the databases. Without the data dictionary 104 the database management system is unable to access data from the database. In an overview, the invention's databases provide an entry for each individual record file and each entry is tagged with the media access control (MAC) address of the source camera, the IP address of the source camera, the date and time the record started, the date and time the record started and ended, and all alarms associated with that specific record. All such data will represent one entry in the SQL database 85, for example. The file containing the digital media is itself not actually recorded in the SQL database 85 but the database simply points to the proprietary format file which is stored elsewhere in the filing system of the recorder. Furthermore, the database entry maintains whether the file is located on a hard disk or if it has been copied to a tape archive, or deleted from the system altogether. If the file was deleted it can be determined if it was done automatically or performed by an operator. Further options allow for determination if the file was ever exported to a CD or DVD, who did it and what were the user's notes. All such informational mining ability ensures that operators have a high degree of accountability, and can lead to better security monitoring practices.

In further reference to FIG. 1 is shown a protocol layer 30. The protocol layer effectively disassembles network data from a packet when received off the network 35 from a specific appliance/device and converts the data into a meaningful database entry. For example, the protocol layer 30 takes database changes (e.g., when a user configures the system via a workstation 150) and converts the changes into specific network 35 commands and sends these commands over the network 35. The present invention utilizes a generic protocol layer 30 to enable the end user greater ease in configuring 3^{rd} party devices to the network 35.

In continued reference to FIG. 1 is the object processing layer 95 as relating to the system's 1 architecture and will now be explained. The object processing layer 95 comprises five individual layers each providing object intelligence processing that can run on an integrated suite workstation PC 150, system server PC 155, on a dedicated network appliance, or run in a video appliance. The video clip export portion 105 and replay incidents 106 operate as a standard part of video 20 as shown in FIG. 1 and allow for export of anything replayed or generated from searches. Motion search 109 operates with live and/or pre-recorded video, wherein the user can set up regions of specific interest in a camera's field of view. For example, the camera can be configured to provide all instances where motion occurs in the specific field of view region of interest. In this situation, the system will remain idle until something enters that designated field of view. If in the case of a pre-recorded file, the system can rapidly scan that file and place bookmarks in each section that had motion in the specific field of view region of interest. Object recognition 108 provides the ability to scan segments of video and recognize/distinguish objects, features, colors, etc. Behavior recognition 107 provides the ability, for example, to determine if somebody/something is moving in a specified direction or if someone/something has remained in a specific area beyond a given amount of time. If this occurred an alarm can be set to be triggered.

Now referring to FIG. 2 is a diagram depicting the network topology and an example of various system components that are associated with the integrated security suite of the present invention. The security suite network topology depicted in FIG. 2 provides for integrated workstations 150 functioning as a Client side operation within the Digital Media System (DMS) (explained below) or the integrated security suite. The integrated workstations 150 have suite software plug-in modules that can be selectively loaded that relate to video 20, audio 25, alarm management 15, access 10, and media storage 75, all of which will be further detailed hereinbelow. The integrated workstations 150 allow the user to configure network appliances (explained above) via a Windows environment so as to enable the user to have a management interface that shows all installed appliances/devices and to configure each appliance to operate as desired.

The network appliances once configured by the integrated workstations 150 sends notification messages in the form of alarms to a security suite server 155. The user can access a database (84, 85, 86, FIG. 1) of events from the security suite server 155. In addition, the security suite server 155 can be configured to automatically forward various alarms that may require operator intervention (e.g., intruder detect alarms) directly to the guard or appropriate party located at a workstation 150. The integrated workstation 150 can configure the system and provide an interface to configure the system and once configured can request important alarm events be pushed from the security suite server 155 to the integrated workstation 150. In addition, the topology provides for the use of codec rack units 165, servers 155, and other system components to enable the user to direct connect to Ethernet LAN/WAN (TCP/IP) 35 utilizing a communication means such as CAT 5 connections 37.

As is central to the security suite of the present invention is the ease of integration of existing analog cameras 130 and analog PTZ domes 131 by use of analog/network codec cards 165 and units 165, explained in greater detail hereinbelow. By use of the analog/network codec card units 165 a user can continue to use existing analog CCTV units 145, analog cameras 130, analog domes 130, and almost any other currently owned analog equipment while connecting digitally to the network thus allowing full digital capabilities not found by using current analog system equipment. Also provided are network ready components that do not require the use of analog/network codec cards 165 and/or units 165. These components can comprise dual door controllers 160, network cameras 140 and domes 135, codec card units 165 video/audio recorder 166, and integrated workstations 150.

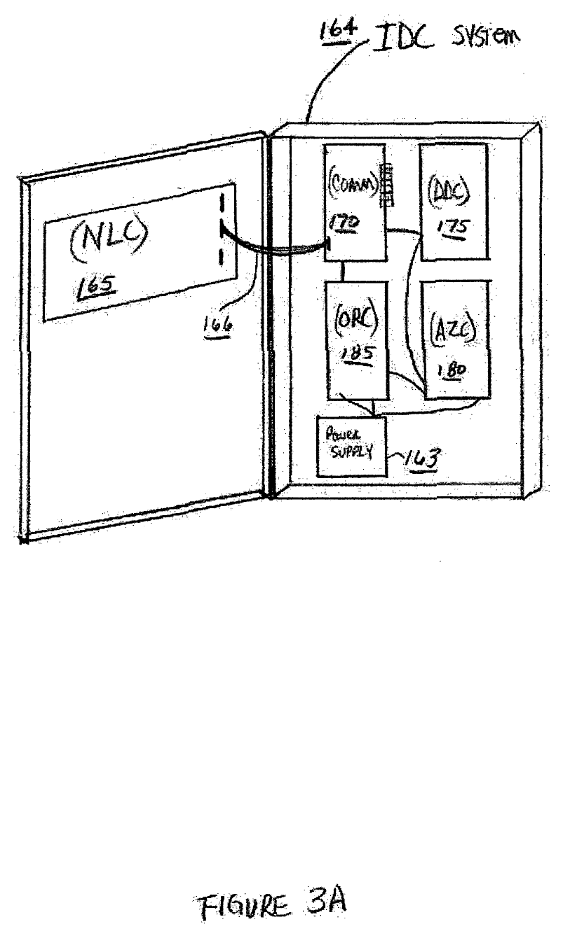

Now referring to FIG. 3B is a diagram depicting an overview of the security management system 2 configuration of the present invention. The security management system suite provides completely centralized security alarm management incorporating security intrusion detection monitoring, annunciation and reporting, alarm management, arming control, and event and response logging/archive, in conjunction with card access/entry control, personnel administration, digital video, audio monitoring and recording, and integrated video imaging/badging all integrated into the same application. The suite incorporates an easy-to-use graphical user interface (GUI) with simple point and click database editing and system monitoring controls.

The system 2 suite is comprised of at least one server 155 comprising a high-end Pentium Class PC with at least Windows 2000 and a database such as Microsoft SQL server database 85/80, at least one workstation 150 comprising a high-end Pentium Class PC with at least Windows 2000 with a maximum of 255 workstations (standard 150 or badging 152) per system, and at least one badging workstation 152 all connected via Ethernet LAN (TCP/IP) 35. The SQL server provides complete transactional data integrity, automated backups, automatic maintenance, and provides an open architecture for interfacing to any other ODBC capable database. This system comprises a multi-user, multi-tasking computer-based package that provides real-time, distributed processing and control of numerous system functions and capabilities. These services are completely integrated into a single system platform wherein the entire alarm management module 15 features and operational capabilities are performed by the base functional program software and can support very large, scalable security systems to span large geographical areas and use the central station alarm management design. The suite further uses plug-in applets, as mentioned earlier, that are small modules dynamically loaded into the framework to provide comprehensive current features, as well as future new or special capabilities developed for the suite. This represents a level of expandability and customization capabilities required for today's high security industry.

The Integrated Digital Controller (IDC)

Now referring to FIGS. 3A and 3B, the IDC 164 is a fully distributed network security management system. The Network Local Controller (NLC) 165 and Communication (COMM) 170 board module (both explained in detail hereinbelow) make up the IDC 164 management components that link between a SAFEnet™ system server 155 and other IDC 164 panels containing IDC 164 field hardware. Available in the IDC 164 system is IDC 164 hardware comprising at least one network local controller (NLC) 165 connected by a ribbon cable 166 to at least one communications board (COMM) 170 and functionally connected with at least one or more field devices. These field devices comprise an alarm zone controller (AZC) 180 which monitors supervised alarm inputs 181, a dual door controller (DDC) 175 which supports access control, and/or an output relay controller (ORC) 185 module which controls relay outputs 186. Also utilized by the NLC 165 is at least one arming control unit (ACU) 190, wherein all arming control is performed. Each of these controllers 175, 180, and 185 connects with the NLC 165 system processor using a communication means such as any of the 8 independent RS-485 communications ports 200 available on the COMM 170 module. In addition, a self-contained power supply unit 163 is supplied as part of the IDC 164 cabinet enclosure. All device modules, controllers, and other associated alarm management components will be explained in detail hereinbelow.

An NLC/COMM 165, 170 management package may be installed in a separate or shared IDC 164 enclosure with other device controllers. The IDC 164 is constructed in at least three enclosure types: single, dual, and quad (all not shown). These options provide the installing integrator a wide range of selection that will easily meet most installation requirements. All IDC 164 enclosures are provided with locks, tamper switches and mounting holes and studs (not shown). IDC 164 systems are configurable using any combination of field device modules, up to 64 card readers, 32 DDC modules 175 and/or up to 512 I/O. A total of 48 device module addresses are supported in a single IDC 164 management system and up to 64 IDC systems are supported by a basic SAFEnet™ server 155.

The Network Local Controller and Communications Board (NLC/COMM)

In further reference to FIG. 3B, the NLC 165 comprises a micro-controller consisting of at least a 32-bit microprocessor having at least one fully integrated, onboard 10-Mb Ethernet, TCP/IP LAN communication port 199 for host communications as well as at least eight RS-485 ports 200 located on the COMM board 170 for security module communications and at least one RS-232 port 198 for diagnostics purposes. In addition, the NLC 165 contains 4 MB FLASH ROM memory for downloaded software code and configuration parameters and a static 16 MB RAM (expandable to 64 MB) for database, data parameters, and transaction/event storage. The NLC 165 can support local event storage of over 10,000 access and alarm transactions and 64,000 card records (expandable). The configuration may further contain multiple NLCs 165 each having multiple communication means such as up to eight RS-485 communication channel ports 200 (maximum of 4000 ft. per RS-485 port 200) for local system communication and direct interface to the AZC 180, DDC 175, and/or ORC 185 modules, as well as other field devices comprising arming control units 190.

The NLC 165 serves as the local system controller processor board 165 and can comprise a plurality of configurations as desired by the end user. For example, a first NLC 165 can control a first AZC 180, a first DDC 175, and a first ORC 185. A second NLC 165 can control a second AZC 180, a second DDC 175, and a second ORC 185. Both the first and second NLC 165 are controlled by the IDC 164. The NLC 165 effectively passes appropriate cardholder records to each dual door controller DDC 175. The DDC 175 can make access control decisions for its two readers (not shown) using its cardholder database. Access requests are made to the NLC 165 only when a card's data is not in the DDC 175 database. If the data is among the over 60,000 in the NLC 175 database, the NLC 175 makes the access control decision and passes it on to the DDC 175. Access requests are made to the host computer when the card data is not present in the NLC 165 cardholder database. Each NLC 165 is network linked via Ethernet (TCP/IP) 34 to a server 155 running the IDC 164 via an on-board, direct connect 10-Mb Ethernet LAN communication port 34.

In reference to FIGS. 3A and 3B, the NLC 165 links supervised alarm point monitoring and reporting from the AZC 180 (explained below) to the IDC 164 which connects to the base functional program for operator response and acknowledgement. The AZC 180 interfaces to the NLC 165 via a communication means such as a supervised RS-485 channel 195 and provides 16 fully supervised alarm input points 181, along with 4 auxiliary relay outputs 182 per module. All IDC 164 hardware is intended for secure installation mounting in hardware specific alarmed and tampered enclosures (See FIG. 3A). These enclosures are designed to mount the IDC 164 system processor (NLC 165) and up to four device modules inside a large enclosure configuration 164. Other enclosure configurations support a single device module and two device modules (not shown). Power supplies 163 and batteries for module operation are supported in all enclosure types as well.

Arming control for the suite can be performed by an arming control unit ACU 190, as generally shown in FIG. 3B. The ACU 190 includes a digital keypad and LCD display, key switches, and/or simple keypads. Each ACU 190 interfaces and communicates with the NLC/COMM 165, 170 via a communication means such as a 22 AWG, 2-wire twisted pair cable using standard 2-wire RS-485 195 communication ports 205. An ACU 190 is provided to open/close (arm/disarm) an area of alarm zones for one or more designated field devices in the IDC 164 system. Each ACU 190 can be configured to control one account when the field devices (175, 180, and 185) are connected to the same NLC 165. For example, each alarm point on the AZC 180 can be individually categorized in one of five categories that also determine the priority of the alarm point. One of these five default groups is used in configuring the alarm points managed by the arming control system, thereby eliminating the need to have to mask individual alarm points when disarming areas. This default grouping reduces unnecessary activity and reduces configuration requirements during initial system set-up. Up to fifteen ACU 190 units can be interfaced to a single NLC 165.

The ACU 190 uses an unmarked keypad (not shown) in combination with a four-line, 80-character Liquid Crystal Display LCD for security code entry and data selection. Six unlabeled “soft” keys are located above and six below the LCD. In some modes of operation five of the keys above and below represent the numeric keys (0-9). These keys may be labeled in four different methods; horizontal (1,2,3,4,5 on top, and 6,7,8,9,0 on bottom), vertical (1,3,5,7,9 on top and 2,4,6,8,0 on bottom) or, for higher security, Rotational and Rotational-PLUS.

The rotational method presents a new arrangement of number assignments to the keys for each use. The rotation-plus presents a new arrangement of number assignments to the keys after each keystroke. In either Rotational modes the keys are always shown in numerical order, similar to the horizontal method, however the starting point is always different and randomly determined.

This dynamic keypad labeling makes available the following ACU 190 functions:
Provides functionally integrated system of access control, alarm monitoring and facility controls.
OPEN or CLOSE account (requires entry of a 5-digit “user” security code)
Display Account Status: OPEN, CLOSED, ENTRY DELAY or EXIT DELAY
Display Status for up to 64 zones in the account on one screen: SAFE, ACTIVE ALARM or FAULT, ACTIVE ALARM and MASKED, SAFE and MASKED
Display ACTIVE ALARMS only (one at a time) with full descriptive text name Display MASKED ZONES only (one at a time) with full descriptive text name
Display CURRENT TIME or REMAINING OPEN TIME (hh:mm:ss)
ARM, DISARM, MASK, UNMASK individual alarm points, and FORCE CLOSE ACCOUNT with alarm points masked (requires entry of a 5-digit “privileged user” security code).
   The Alarm Zone Controller

In continued reference to FIG. 3B the Alarm Zone Controller AZC 180 is an alarm monitoring field device for use with proprietary integrated digital controllers 164. The AZC 180 functions as an interface between alarm input devices and the NLC/COMM 165, 170 board. The AZC 180 features sixteen supervised inputs 181, four form-C output relays 182 for local annunciation or other purposes, communication means such as one RS-485 device communication port 205, and one RS-232 diagnostics port 183, and one tamper input 184. Application programs (firmware) and zone configurations are downloadable into FLASH memory eliminating the need to physically replace EPROMs for application changes and system upgrades. In addition, the AZC 180 continues to monitor alarms and store events in a high capacity buffer during the loss of any communications to the NLC/COMM 165, 170. When communications are restored, the buffered events will be transmitted to the host.

Each AZC 180 is individually addressed and includes local memory for the storage of configuration parameters and events/transactions. The arming control of the alarm point can be performed with an arming control unit 190 station near the alarm point. The arming control station includes a digital keypad and LCD screen, key switches, or simple keypads as explained above in greater detail. The arming control station 190 interfaces to the NLC 165 through a communication means such as the RS-485 ports 200 and communication channel 195. Each alarm point on the AZC 180 can be individually categorized in one of five categories that also determine the priority of the alarm point.

The Dual Door Controller

In further reference to FIG. 3B, depicted is a dual door controller DDC 175 which functions as an access control field device for proprietary integrated digital controllers 164. The DDC 175 functions as a door interface for the NLC 165 and the network communications board (COMM) 170, integrating card readers and associated door hardware into a single package. More specifically, the DDC 175 provides an interface for at least two card reader inputs 176, complete with separate door monitoring inputs, door lock control relays, warning relays, digital and analog exit request inputs and local processing functions (each not shown in FIG. 3B). Each DDC 175 comprises, but is not limited to, 4 supervised inputs 177 (2 door monitor and 2 alarm inputs), 8 non-supervised inputs (2 request-to-exit (REX), 2 tamper, and 4 auxiliary inputs 176, 6 Form-C output relays 178 (3 per door: door lock, alarm, and spare), and 1 DC output for card reader power (not shown). The DDC 175 unit is configurable for two doors with entry readers or for one door with entry and exit readers.

The DDC 175 includes a high-speed 8-bit microprocessor, downloadable FLASH memory for application programs (firmware), SDRAM for cardholder database and event storage, flexible input and output configurations, two reader ports, and interfaces to the NLC 165 via ports 200 on a communication means such as the RS-485 communications channel 195 via the DDC's 175 RS-485 port 205. The RS-485 communications channel 195 allows the DDC 175 to be located up to 4000 feet from the NLC/COMM 165, 170 (as also with the AZC 180 and the ORC 185). The DDC's 175 memory holds 20,000 cardholders and all access control decisions for its two readers are made by the DDC 175 using this database. When a card's record is not found in the DDC 175 database the card data is passed to the NLC 165 for the access control decision.

Additionally, if communications between the NLC/COMM 165, 170 and the DDC 175 is disrupted the DDC 175 continues to make access decisions for its 20,000 cardholders based on valid cards and PINs. Up to 5,000 events are stored at the DDC 175 and passed to the NLC/COMM 165, 170 when communications is restored. Furthermore, cards that have not been used for a preset number of days are removed from the DDC 175 database and replaced with more active cards. Since the DDC 175 stores the cardholder data locally, it provides relatively fast access grants for improved personnel throughput. Up to 32 DDC 175 devices may be connected to each integrated digital controller system, for a total of up to 64 card-readers at a single NLC 165. The DDC 175 will interface with off the shelf industry standard card readers including magnetic strip, Wiegand-effect, proximity, bar code, and various types of smart card readers, as well as biometric devices such as fingerprint and facial recognition biometrics devices.

In conjunction with the above DDC 175 descriptions, the following comprises a non-exclusive list of DDC 175 features and is not intended to limit the possible features but only to provide a representation of DDC 175 features:
Supports 2 doors with entry readers or 1 door with entry/exit readers
Each reader port has connections for power, data, 2 LEDs and buzzer
Supports industry standard and custom card formats
Stores 5000 events
4 supervised inputs: 2 door monitor and 2 alarm inputs
8 non-supervised inputs: 2 request-to-exit (REX), 2 tamper and 4 auxiliary inputs
6 Form-C output relays (3 per door): door lock, alarm and spare
accepts 6.0-16.0 Vdc power source
downloadable FLASH memory eliminates the need to change EPROMs for applications programming and system upgrades
   The Access Control Terminal

The access control terminal ACT (not shown) is a keypad access control unit and display. The unit operates with the DDC 175 to provide additional security at an entry point by requiring a user to enter a valid Personal Identification Number (PIN) after presenting a card at the card reader. The DDC 175 grants access only when the card is valid and the keypad entries match the PIN for that individual. The PIN can be four, five, or six digits in length.

The ACT uses an unmarked keypad in combination with a four-line, 80-character Liquid Crystal Display (LCD) for the PIN entry. Twelve unlabeled “soft” keys surround the LCD display. The five keys above and below the LCD are used as number keys. The keys on each side of the LCD are for special functions. Each time a user presents a card at the associated card reader the LCD displays a new arrangement of number assignments to the keys. The keys are always shown in numerical order, however each time the code is entered the keys rotate. The LCD has a narrow viewing angle which keeps all but the user from seeing the information on the display panel. This dynamic keypad labeling makes available the following ACU 190 functions:
Key assignments rotate for each usage
PIN may be set to 4, 5 or 6 digits
Tactile and audible feedback with each key entry
   The Output Relay Controller

In further reference to FIG. 3B, the Output Relay Controller ORC 185 is an output control field device for use with an integrated digital controller (NLC/COMM) 165, 170. The ORC 185 provides the system interface between the COMM/NLC 165, 170 and other devices that require relay control. Relay outputs can be linked to any system event or input. Some typical uses include signaling devices, locks, lighting, and devices that can be controlled by Form-C relays. The ORC 185 is interfaced to the NLC 165 on a communication means such as the RS-485 communication channel 195 via RS-485 ports 200, 205 and provides 16 Form-C contact relay outputs 186 and 1 tamper input 184. All applications are downloadable into the ORC's 185 FLASH memory thus eliminating the need to replace EPROMs for application changes and system upgrades.

Each of the primary field devices DDC 175, AZC 180, and the ORC 185 are designed with relays that may be used to activate alert devices such as horn and sirens, and building control items such as building lighting, HVAC, and the like. As customer needs change and grow additions to the system become cost-effective by simply reconfiguring the system or if a large number of relay outputs are required on a project, an ORC 185 can be added to the system.

Digital Media System

The present invention further provides for a digital media system (DMS) that can provide a comprehensive replacement for existing analog CCTV video related security systems. In addition, the present invention is also a system that further provides analog/network codec card rack/units 165 that enable an end user to retain investment in analog equipment while enjoying the benefit of the DMS including audio and video. Th DMS provides a digital video network CCTV replacement that allows current analog systems run by a front end that permits the user to pan, tilt, switch cameras, sequence certain cameras, etc. to continue to execute these same functions but to do them all in a digital network format. The DMS converts the output of analog cameras to digital format and in turn compresses that output to enable it to exist within the allocated bandwidth. The DMS system infrastructure provides such compression for any audio, video, or control function plug-in (see FIG. 1) available within the system via IDC 164 hardware 250. Additionally provided by the present invention are Ethernet 35 ready cameras 140 having a digital CCD, digital processor, and digital output that are compressed and network ready, which enables a video stream to be placed onto a network 35 in a digital format.

Generally, DMS provides advanced hardware and software solutions for digital media management. The DMS integrated solution provides digital video/CCTV from analog video 234 through 2-way audio 239 and data record, and management on both smaller scale LAN environments 35 up to larger scale enterprise WAN 35 applications. Specifically, DMS rationalizes and governs all aspects of the technologies required to provide a digital alternative to analog CCTV 145 and exhibits three main features: high-quality audio & video digitization, compression and transmission, unrestrained scalability of numbers of deployed units, and localized & global applications.

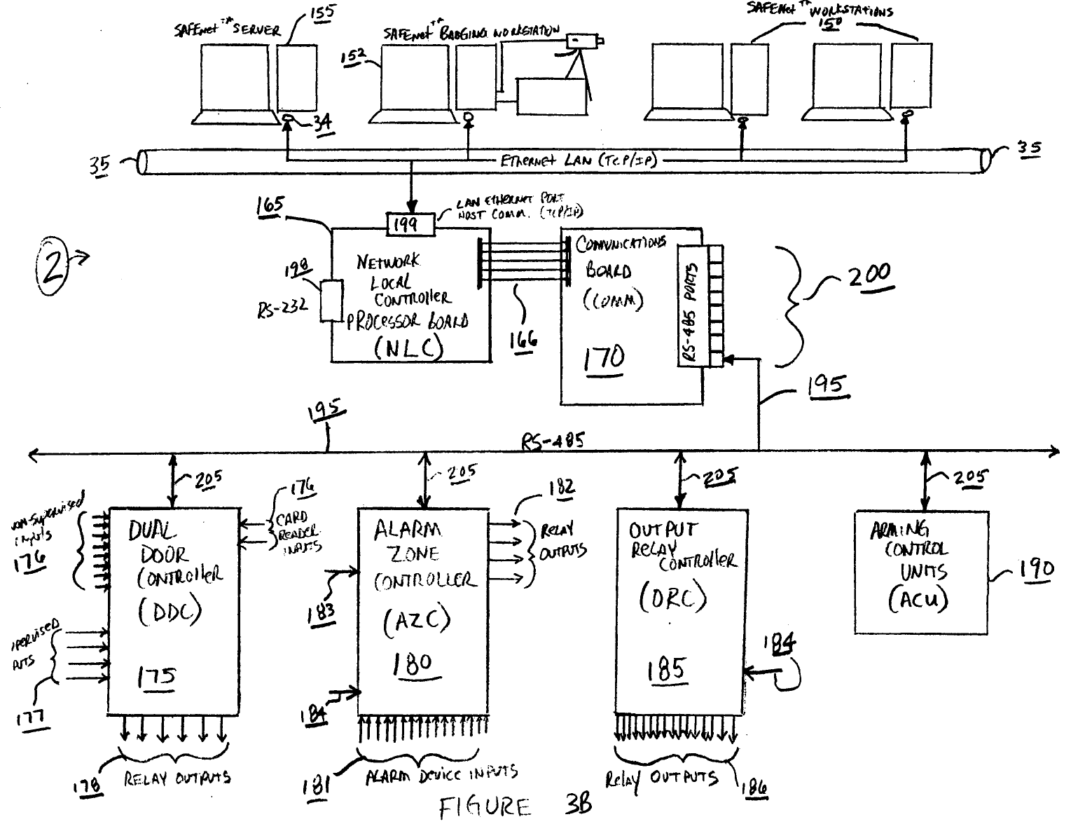

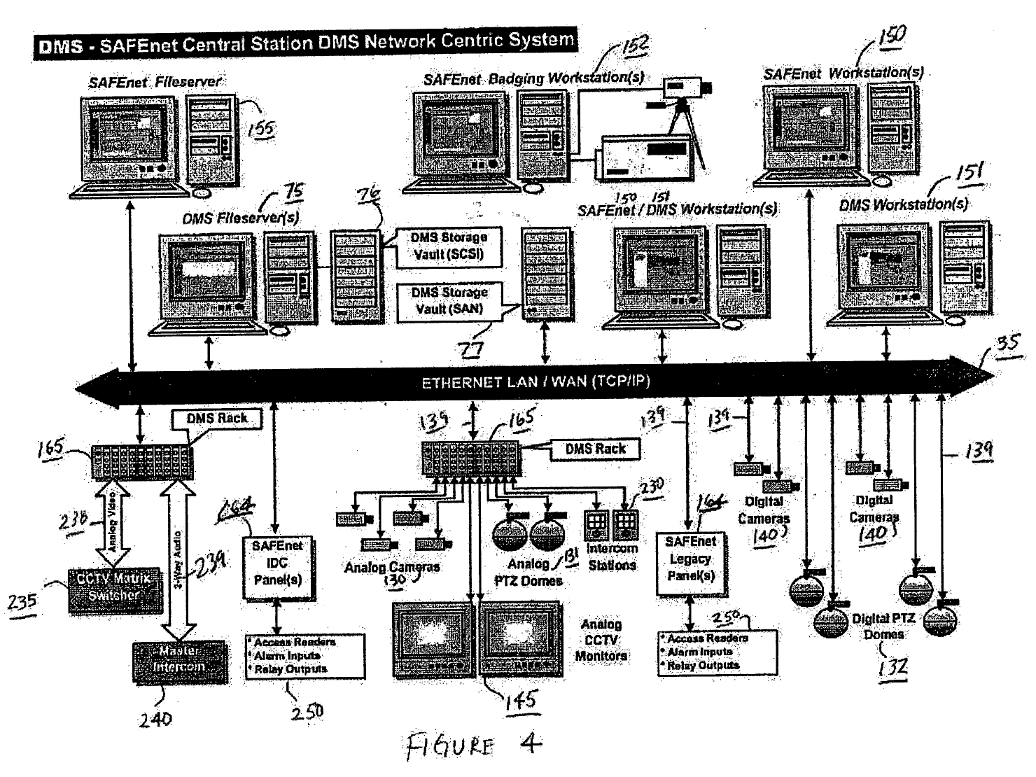

In reference to FIG. 4 wherein is depicted is a SAFEnet™ central station DMS network centric system, and FIG. 5, wherein is depicted DMS is a stand alone system separated from the suite environment utilizing IDC 164 hardware as previously explained. Generally, DMS provides for a digital media system infrastructure utilizing the plug-n-play hardware/software concept. DMS allows for the replacement of massive analog matrix switchers 235 as found in the prior art (e.g., utilizing coaxial cable in from an analog camera and out to analog monitors, thereby allowing a user to switch any camera to any monitor etc.). In DMS essentially the same operations are done but are completed digitally with IP switching on a network 35 via DMS codec racks and units 165 for analog equipment. This effectively eliminates the need for a large switch and the necessity of expensive home run coaxial cables. Therefore, instead of an installer running coaxial from an analog camera the installer instead runs a communication means such as a CAT 5 cable 139 from a digital camera 140 to a workstation 150, 151, 152 to allow for high resolution video viewing. The invention accomplishes these tasks through digital media racks 165 for use with analog equipment and/or digital cameras 140 situated on a network 35 but where the digital cameras 140 are not even associated with the actual digital media racks 165 themselves. In this situation the DMS rack 165 is used to convert existing in-place analog cameras 130 to the network 35.

Referring to FIG. 4, the digital media system herein provides for inclusion in a network centric system with access control integrated in with alarm management via SAFEnet™ IDC panel and hardware 164 (explained earlier) and complete with digital media and is provided via SAFEnet™ software/hardware (IDC hardware 164, 250, fileserver 155, badging workstations 152, and SAFEnet™ workstations 150), associated DMS workstations 151, servers 75, and storage vaults 76. This integrated network centric system version provides an advanced system integrating access control, alarm management, analog/digital CCTV management, 2-way audio 239, 240 and much more.

Referring generally to FIG. 5, in addition to integration with the SAFEnet™ security management system software and hardware 150, 152, 155 DMS can operate as a stand alone digital audio/video and control functions system without integration of specific suite plug-ins. As a stand alone system, the DMS offers all the features, capacities and capabilities for digital/analog video control functions, and audio applications. With this arrangement the user need only deploy cameras and domes 130, 131, 140, 141 exactly where needed as long as access to the network (LAN, WAN, etc.) 35 is available. This ultimately eliminates the need for large & expensive coax cabling overheads as well as matrix switching 235 technology and the need for an integrator to install the system. Additionally, with use of the DMS system the user has the option and functional capability to integrate in access, alarm, and/or video functions or a combination of all of the above (see FIG. 4 generally).

This provides value added in that when an alarm occurs the user can program exactly what the video is supposed to do (e.g., record, sent to NY, be put on a hard drive, be put on a floppy drive to go to the police, etc.). The current invention provides a mechanism that on the event of an alarm or event to turn on a recorder to record or to route the video to a place to alert an end user. These services are integrated all into one software package and are provided by the disclosed system. Therefore, with use of the DMS software of the current invention, the programming of a camera is not unlike the programming of a door or an alarm event in the alarm management system. The strength provided herein is found in the integration of access control and alarm management. Ultimately, DMS provides the functional and operational capability to have CCTV 145 with full resolution, full bandwidth, and full frame rate video all transmitted and available on a digital network.

According to one embodiment of the present invention every camera 140 in the system captures and records every frame of information and time stamps any alarms occurring to a particular frame in time. This full record mode enables the user to view frames in real time that occurred prior to that specific alarm. To accomplish this, DMS uses an efficient & optimized MPEG 4 compression algorithm as compared to those in the art. This technology delivers MPEG 4 quality full resolution video on a network 35 but at the lowest bandwidth that exists today. This provides a resolution equal to the resolution of a good digital camera 140, which is typically beyond the capabilities of a standard analog camera. In addition, by time stamping or tying alarms or events/triggers to a specific time in a stream of video, the user can go backward or forwards within a specific stream of video to view the full scene.

The digital cameras 140 and domes 141 of the present invention are placed in the field having no fixed IP address. The DMS system software searches the IP address and assigns each unassigned camera in the field an IP address based on the camera's media access control (MAC) address. To accomplish this, the DMS system software uses Dynamic Host Configuration Protocol (DHCP). The operating principle of DHCP assumes that a device (e.g., a camera) knows nothing about its own network settings and sends out a broadcast packet essentially requesting instructions. That is, for example, as soon as a device is plugged in the device wakes up with a MAC address and begins requesting a DHCP address. The DHCP server listening for these packets responds with a packet containing the settings that that specific device should have. To accomplish this, the DHCP server is configured with a table of Ethernet addresses, ranges of IP addresses, and maps that describe which device gets assigned which IP address. In the present system, a DHCP server is set up on the network 35 and that DHCP server will assign IP addresses randomly to devices (e.g., cameras 140, domes 141, etc.) whose MAC address is not predefined. However, if a device does have a predefined, recognized MAC address the DHCP server will always assign that device the same IP address, allowing for consistent deployment of the DMS devices. The DMS system of the present invention will further convert that IP address to a logical address (e.g., the camera at the front door). Once assigned, the DMS system's management software enables the management and client devices of the present invention to search and discover where all client owned equipment is located, the IP addresses, and what the specific configuration of the devices are. This characteristic fundamentally changes the way an operator of today installs equipment (e.g., cameras 140, PTZ domes 141, etc.) onto a digital network 35. In this particular application, the operator never needs to see an IP address to install DMS equipment. This is analogous to current hardwired CCTV systems installed today. The present invention additionally provides for a DMS specific protocol in connection with or in place of the DHCP protocol that will take care of the IP addressing needs and leaves as the only task to the operator of that of simply “plugging-in” the desired device (rack unit 165, camera 140, PTZ domes 141, workstations 151, etc.) onto the digital network.

In further reference to FIG. 5, the DMS, by virtue of its ability to interface with both digital technologies and older Analog technologies, permits the creation of true “Hybrid” CCTV systems. Such systems preserve existing CCTV investments while bringing them into the Digital Age. To enable this preservation the DMS provides for digital video inputs, analog inputs (cameras, switchers, etc.) and analog outputs (video monitors). Currently the DMS operates under Windows 2000 client/server architecture and provides up to 100 video streams per server each at up to 30 fps (up to 3,000 fps/server). The DMS provides unique MPEG-4 network video encoders and decoders (CODECs) 165 with the expansion to meet virtually any application that is available with additional servers 75, storage 76, workstations 151, and codec racks/modules 165.

Furthermore, the present invention provides for a much needed IP switching capability, extensive motion, event and time based recording and flexible search and playback. To accomplish this DMS provides hardware consisting of various component features as will be explained below.

With reference to FIG. 5 there are two types of computers in the DMS system: the DMS digital video fileserver/recorder 75 and the DMS workstation 151.

DMS Digital Video Fileserver/Recorder

The fileserver 75 (Server) is a dedicated, high end Pentium Class computer running Windows 2000 (or a later Microsoft OS for Intel x86 architectures) and is optimized for the input channel and storage capacity requirements of the specific application being supported. The fileserver 75 is capable of recording up to 100 video streams at up to 30 fps each and can be installed in multiple server units depending on the size and need of the user's application.

DMS Workstation

The workstation 151 (Client) provides the primary human interface to the DMS system. The workstation 151 can either be a dedicated Windows 2000 based PC or can be applied as an application running on existing Windows 2000 based PCs. To further expand the integration and interoperability of the DMS system, the SAFEnet™ DMS client workstation 150 (see FIG. 4) integrates the DMS functionality along with the DMS client workstation 151.

DMS Storage Vault(s)

With continued reference to FIG. 5 what is shown as providing primary media storage 76 and retrieval function is the DMS storage vault(s) 76. The vault(s) 76 is managed by the DMS fileserver 75 as described above and is available as direct connect to the fileserver (SCSI) 76 or networked (SAN) 77. A storage area network (SAN) is a high-speed special-purpose network (or subnetwork) that interconnects different kinds of data storage devices with associated data servers on behalf of a larger network of users. Typically, a storage area network SAN is part of the overall network of computing resources for an enterprise. A storage area network is usually clustered in close proximity to other computing resources but may also extend to remote locations for backup and archival storage, using wide area network carrier technologies. Additionally, SANs support disk mirroring, backup/restore, archival and retrieval of archived data, data migration from one storage device to another, and the sharing of data among different servers within a network. SANs comprise the capability to incorporate subnetworks with network-attached storage (NAS) systems.

In addition, the storage vault(s) are configurable up to many terabytes and can be installed in multiple units as may be required by the application.

DMS CODECs and Rack Unit(s)

In further reference to FIG. 5, the DMS CODEC (COmpressor/DECompressor) rack 165 units encode and decode analog video 238/audio 230, 240 to and from 239 digital formats for storage, retrieval and transmission. What is provided in DMS is a standard EIA 19″ rack unit (RU) 165 that comprises a backplane, power supply, connectors, and slots for a plurality of modules. Typically, at least ten rack mountable DMS codec modules such as the DMS 4 channel I/O codec and the DMS 1 channel I/O codec (neither shown) are provided. The DMS 4-channel codec is configured as an encoder for video/audio inputs (Server) or a decoder for video/audio 238, 239 outputs (Client) and is further available as rack mountable 165 or with a specific dedicated enclosure (a unit). Similarly, the DMS 1-channel codec is configured as an encoder for video/audio input (Server) or a decoder for video/audio output (Client) and is also available as rack mountable 165 or as a unit.

In addition, the present invention further provides for the installation of DMS codec cards into existing equipment (e.g., analog monitors 145, etc.) to allow a user to utilize plug-n-play type network appliances that are a CCTV system where no coax cabling is involved. Additionally, the codec cards disclosed herein uniquely places object processing intelligence directly onto the codec card itself so as to allow certain decisions to be made at the camera level itself. In this specific application each camera containing the codec is enabled to make object processing decisions that can, for example, set an alert or alarm and can force streaming/recording of video or can stream video of an event that is occurring directly to a cell phone, personal digital assistant (PDA), or other similar devices. For example, a flag could be preset in the codec to send a picture of a lobby if a person has been loitering in the lobby for “X” minutes or if motion is detected such as a door opening or someone turning on a light.

DMS Digital Cameras

FIG. 5 also depicts DMS digital cameras 140 comprising the built-in CODEC modules and are designed to be functionally and communicably connected directly to a TCP-IP network 35.

The DMS software utilized by the present invention consists of a plurality of features as will now be explained.

DMS Software Overview

The DMS software is provided for both the DMS Server/Recorder 75 and the DMS Client Workstations 151. The DMS fileserver 75 software provides the central management for network traffic, recording, and distribution. DMS storage is provided locally and/or via SCSI/SAN RAID unit vaults 76, 77. The DMS workstation 151 software provides for local viewing of live and recorded video, audio, control of PTZ cameras, and to send/receive data streams and more. Administration functions permit those authorized to have full access to remotely administer the DMS System. This is also available as an integrated module for SAFEnet™ Workstations 150, 152 (see FIG. 4).

DMS—Network & Storage Considerations

Network based digital video transmission and recording can be very demanding of network bandwidth and can require vast storage arrays. There are many means of reducing this demand in the current art. However, most of these means has a dramatic impact on the system; for example: utilizing the lowest frame rate/bandwidth possible, which causes a user to rethink if certain cameras are needed in specific locations. Other means with detrimental side-effects are to attempt to utilize medium resolutions as much as possible, using high-resolutions only where necessary, lowering the frame-rate on time recordings, to increase on motion/event based recordings, to consider additional recorders in alternate locations, and to keep live video viewing stations to a minimum. However, the DMS negates the need to reduce the security aspects of the system without having to pay high-costs by utilizing a high efficiency codec platform that generates high quality video at network and disk utilization levels that other systems can only match at low quality video settings.

By moving to DMS network devices, instead of prior art methods of pure analog systems, the present DMS system can control and monitor any device at any time. Within the DMS architecture, system controllers have access to the devices on the core network (local or remote) to which they have authorized access. All access rights and the granting of permissions are controlled through the core network's site manager which in turn is managed locally or remotely using secured software.

Additionally, the DMS system provides for audit traces of specific device or system commands, configuration changes and user-logins through networked command and data loggers. Coupled with rules and filters the data loggers can also be used to detect, in real-time, any behavior that may be considered suspicious, helping to detect electronic attacks that may occur before physical ones.

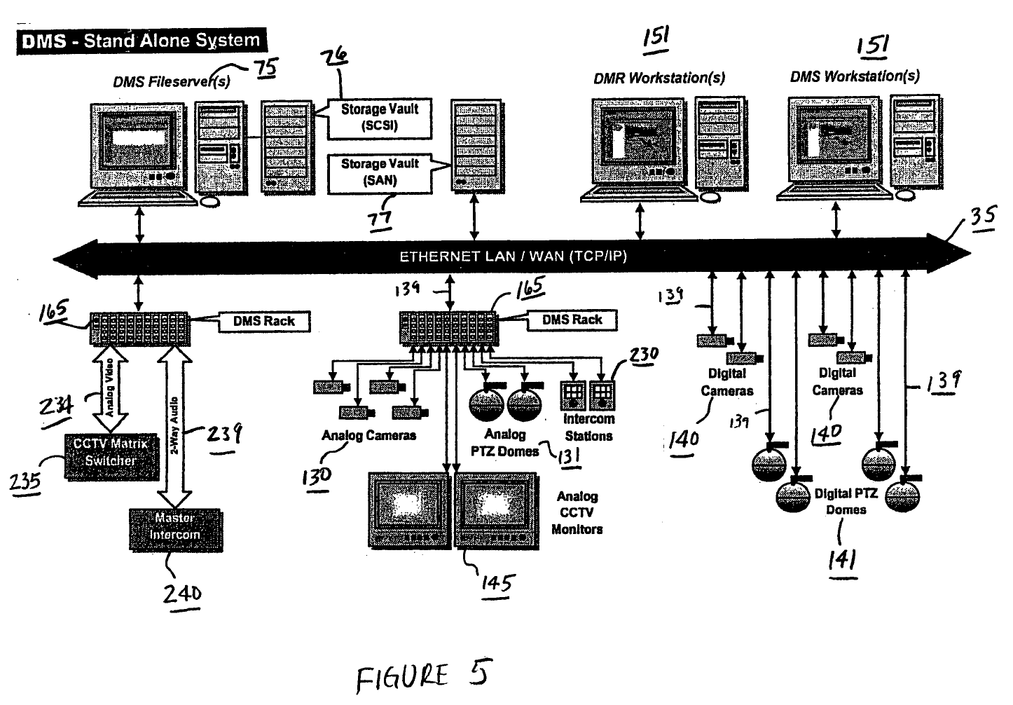

Now referring to FIG. 6, the DMS system including the DMRS 160 (explained below) has full functional ability to integrate DMS with existing analog infrastructures 130, 145 (Site A & Site B in FIG. 6) and third party devices such as domes 131, or matrix switchers 235 without requiring the replacement of and loss of initial investments in existing analog equipment 130, 131, 145, 235 by utilizing analog/network codec card unit converters (DMS rack) 165 as described earlier. All analog devices depicted in FIG. 6 can be controlled from the DMS system software and workstations 151 and will further allow similar products from existing systems to successfully convert to the digital system without removing or replacing existing analog cameras 130, monitors 145, and recorders. Plug-ins suitable to the product being interfaced are simply added as required to the DMS system saving the user time, money and effort in maintaining two sets of equipment that perform nearly parallel functions.

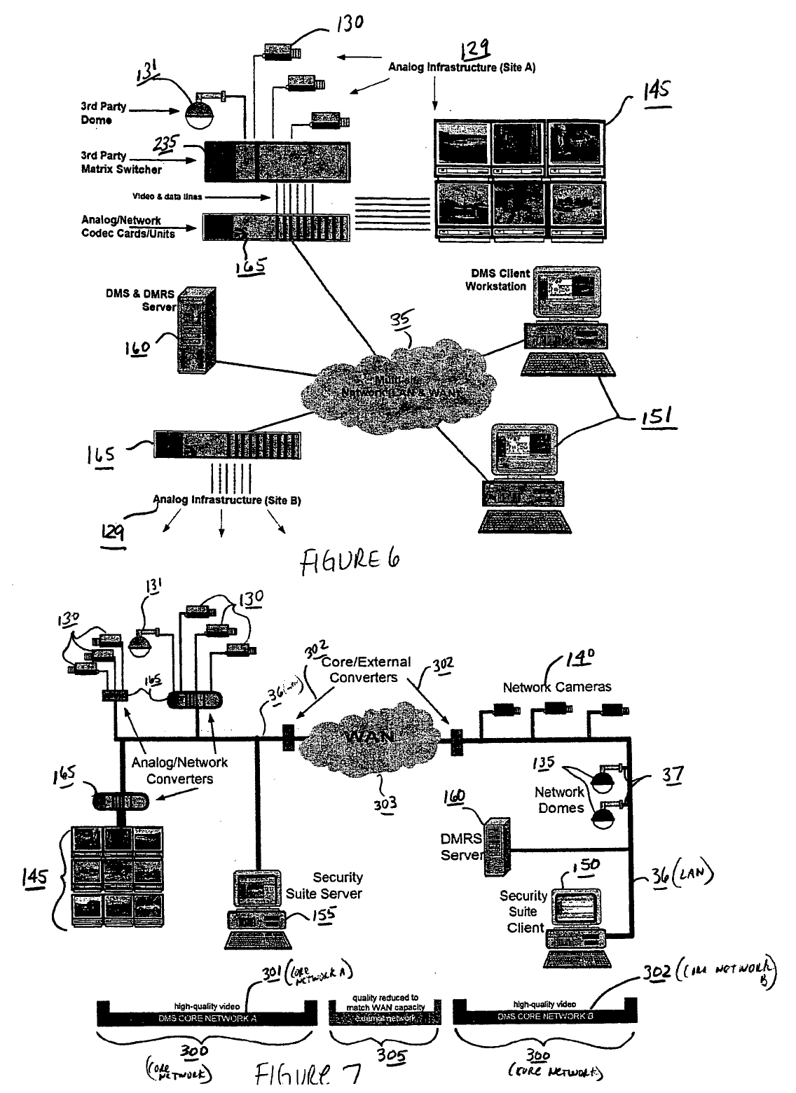

Now referring to FIG. 7, the DMS herein defines two types of networks, a core network 300 and an external network 305. A core network 300 is essentially comprised of either 100Base-T or 1000Base-T Ethernet 36 devices. A core network 300 usually consists of a local area network LAN 36 wherein a core network 300 is a “deterministic network,” that is, wherein the network's 300 data capacity, error rate, etc. is easily determinable. These deterministic attributes are predictable properties of a core network 300 LAN 36 and across the entire network 36 it is known that these properties will support high quality video at high data rates and a high number of channels are all available in the core network 300. Additionally, core networks 300 comprise the capability to carry hundreds of high-quality, high resolution and high-frame-rate video channels. This capability cannot be delivered by any other network, and consequently the core network 300 requires careful consideration in its design. DMS system devices operating in the core network 300 always share and maintain high-quality streams without dramatically affecting the real-time performance of the video and audio encoding processor.

FIG. 7 further shows a DMS core network “A” 301 and a DMS core network “B” 302 wherein core network B 302 provides for DMS digital devices that are direct copper CAT 5 wired 37 Ethernet devices to a copper CAT 5 type network 36 and do not necessitate an interface box (codec rack unit) 165, which requires further additional signal conversion. In contrast, core network “A” 301 in FIG. 7 shows the use of such an interface box (DMS codec rack unit) 165 that enables a user to connect existing analog devices (e.g., cameras 130, PTZ domes 131, etc.) and convert to a digital format for network 36 connection and transmission.

In further reference to FIG. 7 an external network 305 is depicted. An external network 305 is defined herein and provides for any other network besides a core network 300 as described above. One example is a wide area network (WAN) 303 interconnecting two facilities. Unlike a core network 300, the capabilities of external networks 305 are typically left with the control of an integrator for the customer. This requires the DMS system to tailor media transmission to match the real-time capability of the external network 305. More specifically, video and/or audio quality may need to be reduced to match the WAN 303 capacity. Devices in the external network 305 connect to core networks 300 via the external network using core/external network converters 302 and must modify their encoding to match the external network's properties in real time. For example, an external network 305 would be any kind of network regardless of data capacity that requires some form of media conversion. Unlike a core network 300, however, the external network 305 and its properties and the technology being used for conversion and its properties are very unpredictable.

The present invention further provides for a transcoder device 302 that assists an end user in remote connectivity to a system. The transcoder device of the present invention assists the user in streaming a plurality of information when a limitation to the streaming bandwidth exists or is presented regardless of the cause of the restraint. The transcoder device permits continuous high resolution (30 fps) recording while reducing the streaming frame rate to accommodate a lower bandwidth that may be needed by the end user. The transcoder device has specifically defined application when a user desires to be alerted of an event (alarm condition etc.), for example, on a personal digital assistant or cell phone when there is limited bandwidth available. The transcoder device allows for necessary reduced quality (accomplished via reduced resolution, quality, and/or frame rate) to be streamed although the recorder 160, 166 continues to record high resolution, full frame rate, and for recorded files to be played back to remote devices at a quality suitable to the remote device's connection.

Although previously generally referenced in FIGS. 4 through 7, the present invention provides for a digital media recording system (DMRS) 160 storage medium 76 that is functionally operable as a separate server 160. In this embodiment the DMRS 160 software of the system is multi-configurable and can record various types of media having at least 100 streams of information while playing back the media on 10 or more monitors in full resolution digital video. In addition, the DMRS 160 system allows for the playback of a file that is currently being recorded and operationally and functionally prioritizes the recording of the media above the playback.

The DMRS 160 system is capable of storing media other than just video. The DMRS 160 system can record audio/video from a camera and can also record audio transmitted back to a camera. For example, the system can record and capture what a guard might have the to a person at the capturing end of a camera or other device. In addition, the system records other auxiliary data which in itself is bi-directional in nature. The recorder of the present invention is capable of recording in 5 channels of data with the current file format. For example, there is 1 video channel from the camera, 2 channels for audio to/from the camera, and then 2 channels for Input/Output data to and from the camera. This 5 channel capability enables audio/video and all aspects of other communications associated with data for each specific camera on the network to be recorded. Such recorded information comprises control data including opening doors, closing doors, panning, tilting, and the changing of multiplexer channels this all being done in conjunction with audio and video media information recording.

The DMRS 160 is designed to utilize all the disk space a system has to ensure that the user has recorded all frames and pixels until the disk full, making use of their investment to the maximum. It is not until the disk is full that the system and/or user decide what must be deleted and what must be kept. It is at this point that the use of recorded trigger information becomes useful as will now be explained. In the DMRS 160, during the recording of events or external triggers, the recording frame rate does not change as is common in prior systems. However, in the DRMS 160 “alarms” are tied to the video stream to indicate to the user that certain specified portions of the video contain video relating to events or triggers that may be useful. As described above, when the disk becomes full and a determination has been made to delete information, only those portions of the video having no alarms associated with specific segments of video can be selectively deleted by the user. This option allows the system and/or the user to have time to go to any of these video segments and flag them as “do not delete” segments. In addition, the DMRS software enables a user to indicate when certain events or alarms have happened in the video (e.g., motion detected, or when a pressure mat was stepped on) for later review and evaluation.

The DMRS 160 utilizes a proprietary synchronization scheme wherein information being recorded is synchronized in time down to milliseconds. The DMRS 160 system time stamps at least the networked cameras 140 and controllers. Each camera module, microphone etc. contains an internal clock which enables synchronization of video and audio but is ultimately synched to the controller and has only one CAT 5 plug coming from the board. If a situation arose wherein the video from one camera, the audio from another source, and control data from another source all are being stored into the same file, millisecond clocks are used to track the clock drift of various platforms and are assigned a millisecond time stamp by the recorder itself. Ultimately, all network packets and control data to be recorded are picked up by the recorder 160. A worst case scenario would cause the alignment of all recorded information be according to the controller block itself.

Although the invention has been described with reference to one or more preferred embodiments, this description is not to be construed in a limiting sense. There are possible modifications of the disclosed embodiments, as well as alternative embodiments of this invention which will be apparent to persons of ordinary skill in the art. Therefore, the invention shall be viewed as limited only by reference to the following claims.

1. A digital media system for media capture and management, the digital media system comprising:
a means for capturing a real-time media signal via a capture device;
a means for receiving the media signal into the system after the means for capturing has captured the media signal;
a means for storing the real-time media signal as the media signal is captured and received into the system;
a means for retrieving the real-time media signal from the means for storing;
a means for viewing the real-time media signal;
a means for relaying the received media signals over a network from a first location to a second location;
a means for managing the means for capturing, receiving, storing, retrieving, viewing, and relaying of signals of digital media system; and,
a means for providing remote access to the recording system via the means for managing, wherein the means for providing remote access authorizing full access to administer the system.

2. The system in claim 1 wherein the real-time media signal is obtained from a video camera.

3. The system in claim 1 wherein the real-time media signal is obtained from an intercom.

4. The system in claim 1 wherein the real-time media signal is obtained from a video camera and microphone combination.

5. The system in claim 1 wherein the real-time media signal is obtained from a digital dome.

6. The system in claim 1 wherein the real-time media signal is obtained from a video camera and a digital dome.

7. The system in claim 1 wherein the real-time media signal is obtained from a combination of video cameras, digital domes, and intercoms.

8. The system in claim 1 wherein the system is operationally functional in local area network (LAN) environments.

9. The system in claim 1 wherein the system is operationally functional in wide area network (WAN) environments.

10. The system in claim 1 wherein the means for receiving includes digital video inputs.

11. The system in claim 1 wherein the means for storing is a server/recorder.

12. The system in claim 11 wherein the server/recorder functions as a Storage Area Network SAN.

13. The system in claim 11 wherein the server/recorder communicates to the system via a SCSI parallel interface.

14. The system in claim 1 wherein the means for receiving comprises digital video inputs.

15. The system of claim 1 further comprising:
a record software;
a record server operative via the record software;
a record client functionally connected to the record server;
a playback means communicably coupled to the record server, wherein the playback means can playback multiple pre-recorded clips during a concurrent playback session; and,
a client computer communicably coupled to the record server and the playback means, wherein the computer accesses the record server to retrieve clips for preview and/or export.

16. A hybrid digital/analog media system for media capture in a network comprising:
a means for capturing a real-time media signal via a digital capture device;
a means for receiving the media signal into the system after the means for capturing has captured the media signal;
a means for storing the real-time media signal as the media signal is captured and received into the system;
a means for retrieving the real-time media signal from the means for storing;
a plurality of interface means for converting stored media signals from an analog format into a digital network format after the means for capturing has captured and the means for retrieving has retrieved the media signal;
a plurality of interface means for converting stored media signals from a digital network format into an analog format after the means for capturing has captured and the means for retrieving has retrieved the media signal;
a means for relaying the converted media signals over a network from a first location to a second location;
a means for managing the means for capturing, receiving, storing, converting, and relaying of signals of digital media system; and,
a means for providing remote access to the recording system via the means for managing, wherein the means for providing remote access authorizes access to administer the system.

17. The system of claim 16 wherein the system is flexibly expandable through additional servers, storing means, and interface means modules.

18. The system of claim 16 wherein the interface means is configured to convert from analog to digital video.

19. The system of claim 16 wherein the interface means is configured to convert from analog to digital audio.

20. The system of claim 16 wherein the interface means is configured to convert audio and video from analog to digital.

21. The system of claim 17 wherein the means for relaying comprises the Internet.

22. A hybrid digital/analog media recording system for media capture in a network comprising:
a means for capturing a real-time media signal via a capture device;
a means for receiving the real-time media signal into the recording system after the means for capturing has captured the signal;
a plurality of servers for storing the real-time media signal as the media signal is captured and received into the system;
a means for retrieving the real-time media signal from the plurality of server means for storing;
a digital network connected to the plurality of server means for transmitting the signal, the network comprising:
a local area network (LAN); and,
a wide area network (WAN), wherein the WAN interconnects with the LAN;
an analog distribution network for transmitting the signal;
a plurality of compressor/decompressor units communicably connected to the system, wherein the units encode and decode the media signal to and from digital format for storing, retrieval, and transmission;
a plurality of client terminals communicably interconnected to the digital network and the analog distribution network, wherein the terminals comprise a means for generating messages via the digital network, wherein the means for generating messages is stored in and operable on the terminals;
means for managing the means for capturing, receiving, and storing of signals of digital media system, wherein the means for managing is stored in and operable on the terminals;
means for providing remote access to the recording system via the means for managing and the means for providing remote access, wherein full access is authorized to administer the system, wherein the means for providing remote access is part of the means for managing and is stored in and operable on the terminals.

23. A method for media recording and storage in a network, the method comprising:
capturing a plurality of media at a first location via a capture means;
receiving the media from the capture means;
storing the received media in at least one storage means;
retrieving the media from the at least one storage means;
converting selected media into a predetermined format;
relaying selected media via a network to a second location; and
providing restricted user access to the relayed media.

24. A network topology comprising:
at least one core network having encoded signals, wherein the at least one core network comprises an apparatus, the apparatus comprising:
at least one site manager;
at least one field controller in communication with the site manager;
at least one core security device operationally connected to the controller;
at least one external network operationally connected to the core network wherein the external network comprises:
at least one external security device operationally connected to the at least one external network and a signal on the external network are encoded to match the core network's encoding in real time.

25. The apparatus of claim 24 wherein the at least one core security device is operationally connected to the at least one controller by an Ethernet.

26. The apparatus of claim 25 wherein the at least one core security device is operationally connected to the at least one controller by a CAT-5 network.

27. The method of claim 25 wherein the Ethernet protocol is TCP/IP.

28. The apparatus of claim 24 wherein the at least one external security device is operationally connected to the external network by an Ethernet.

29. The method of claim 28 wherein the Ethernet protocol is TCP/IP.

30. The apparatus of claim 24 wherein the at least one external security device is operationally connected to the external network by a CAT-5 network.

31. The apparatus of claim 24 wherein the core network is operationally connected to the external network by a wide area network.

32. The apparatus of claim 24 wherein the at least one core security device is a digital camera.

33. The apparatus of claim 24 wherein the at least one core security device is an analog camera.

34. The apparatus of claim 24 wherein the at least one external security device is a digital camera.

35. The apparatus of claim 24 wherein the at least one external security device is an analog camera.

36. The apparatus of claim 24 wherein the core security device uses a codec to packetize information into TCP/IP protocol.

37. The apparatus of claim 24 wherein the external security device uses a codec to packetize information into TCP/IP protocol.

38. The apparatus of claim 24 wherein the external network further comprises an external controller.

39. A media management storage medium for storing a computer-readable program for managing and controlling a plurality of network appliances each controlled by a Client, the computer-readable program causing the performance of the following steps:
permitting the view of live and recorded media;
permitting control of media networked devices;
sending data streams;
receiving data streams;
allowing access to the devices for administration of the devices; and,
allowing configuration of the networked devices.

40. A digital media system, the system comprising:
a digital video software plug-in;
a digital audio software plug-in, wherein the audio plug-in communicably operates with the video plug-in; and,
wherein the digital audio plug-in and digital video plug-in comprise an application framework, wherein the plug-ins further comprise value added technology components.

41. The system of claim 40, wherein the technology components are selected from the group consisting of biometrics, asset tracking, visitor system, and disaster recovery.

42. A codec rack unit comprising:
at least one codec card, wherein the card comprises a means for onboard object intelligence processing.

43. A digital Ethernet ready camera comprising:
a digital CCD;
a digital process to control the CCD; and,
at least one digital output means to enable a digital video stream to be transmitted on a network.

44. An analog monitor comprising:
a codec card module; and
a communication means for connecting the monitor to a network.
